(19) United States
(12) Patent Application Publication
(10) Pub. No.: US 2017/0094912 A1
(43) Pub. Date: Apr. 6, 2017

(54) Planter box

(71) Applicant: DAVIE LEE BROOKS, YUMA, AZ (US)

(72) Inventor: DAVIE LEE BROOKS, YUMA, AZ (US)

(21) Appl. No.: 14/756,696

(22) Filed: Oct. 2, 2015

(51) Int. Cl. A01G 9/02; A01G 9/10; A01G 9/24

(52) U.S. Cl. CPC A01G 9/026; A01G 9/247; A01G 9/108

(57) ABSTRACT

A portable planter box especially adapted to be usable either in a commercial or residential environment, providing ease of access and internal irrigation. The device is adapted to be utilized in a minimum amount of space, and to be movable from one space to another. The planter box is uniquely designed to permit stacking and may be collapsed to permit ease of storage and transport to multiple locations.

### CROSS REFERENCE TO RELATED INVENTIONS

NOT APPLICABLE

### STATEMENT REGARDING FEDERALLY SPONSORED RESEARCH OR DEVELOPMENT

NOT APPLICABLE

### REFERENCE TO SEQUENCE LISTING

NOT APPLICABLE

### BACKGROUND OF THE INVENTION

1. Technical Field

The present invention relates to portable planter boxes that find application in both commercial and residential environments. The planter boxes of the present invention may contain virtually any vegetable matter that is grown in soil, and is particularly adapted for raising vegetables and fruits, such as strawberries, broccoli, carrots, and the like. More particularly, a planter box may be comprised of collapsible wall portions to make the device more easily transported and/or stored

2. Description of the Related Art

Planter boxes that are collapsible and which contain internal watering apparatus have been described in the prior art, however there has heretofore not been described a planter box having the unique attributes of the planter box described and claimed herein. The prior art must be viewed in light of the specific features of the present invention described and claimed herein, to wit: portability, collapsibility, elevated off the ground, with built-in heat retention/bird-bug repellant, and internally hydrated.

### BRIEF SUMMARY OF THE INVENTION

Planter boxes have been used in residential environments for years, but have found little or no application in the growing of crops on a commercial scale. The reason for this is that crops are typically grown on very large scale, requiring the use of large tractors and harvesters on large tracts of land, often times with the added requirement that the land be certified organic. With changing food consumption habits, consumers are increasing demanding premium fruits and vegetables that are grown in warm weather climes for winter harvest. Such crop land has increased to prices that exceed the means of all but the richest and largest growers. For example, farm land in and around Yuma, Ariz. routinely sells for $30-40,000 per acre. In the prime warm weather winter growing areas for vegetables and fruit, after the summer heat has dissipated farmers can typically harvest their crop 4-5 times before it becomes too warm again in the late spring/early summer. The land then lies fallow or is planted to less-productive crops.

The planter boxes described herein can be utilized in a small plot commercial environment without the necessity of incredibly expensive land; the planter boxes can be positioned on inexpensive unproductive land of any sort. Additionally, when the prime growing season has passed, the planter boxes can be stacked and transported with soil and plants intact to a cooler clime where the plants remain productive. When growing high value crops such as strawberries, an additional 2-3 harvest cycles greatly increases the economics of small-plot farming. While not required, means may be provided so that when stacked upon one another the planter boxes are frictionally secured one to another.

Separate and apart from the commercial application of the planter box of the present invention, it finds particular application in a residential environment. Many homeowners find it impractical or inconvenient to till a garden in situ; many homeowners don't have the land to do so, and others don't want to, or can't, exert the physical effort to till a garden. The present invention is ideally suited to such environments, as it permits homeowners or farm labor to till relatively small plots without the necessity of stooping over to plant, weed, water and harvest a crop.

In a first embodiment, the planter box of the present invention comprises a stackable box having a bottom and at least 3 side walls, preferably 4, arranged in a square or rectangular orientation. The planter box may be provided with at least three, and preferably 4, removable legs to elevate the box off the ground. At least one of the side walls is provided with a fitting to receive a drip watering system; in a preferred embodiment at least two of the side walls are provided with such fittings to enable the planter box to be positioned adjacent another planter box and the watering systems engaged in series. A mechanism may be provided to secure multiple planter boxes adjacent one another. The bottom of the planter box may be provided with a drain in order to remove excess water pooling in the bottom of the box.

While it may not be preferable in a commercial environment, in a residential environment the planter box may be provided with side walls that either hinge so that they can be laid upon the bottom to reduce the storage size, or alternatively, provided with alternative means for removal and reassembly. An example of such alternative may be walls that slidably attach to one another and to the bottom, as with male-female slidably engaging members.

In either the commercial or residential environment, removable legs are preferable for storage or shipment of the boxes. In a commercial environment, the boxes with soil and plants in place may be stacked and shipped, with the legs removed, to another growing location.

In almost any location there are periods when it is too cool for effective growing of crops. In such cases, providing a “hot box” for early planting of crops extends the growing season and therefore crop yield and profitability. Providing side walls with means to receive support members and flexible cover members to cover the crops will provide a heat trap in cool periods and provide protection against pests and birds when crops are ripe and ready to harvest.

### BRIEF DESCRIPTION OF THE SEVERAL VIEWS OF THE DRAWINGS

FIG. 1 is a perspective view of the planter box of the present invention.

FIG. 1A is an enlargement of the foot of the planter box of the present invention.

FIG. 2 is an expanded view of one embodiment of the planter box of the present invention.

FIG. 3 is an exploded view of the planter box of the present invention.

FIG. 4 is a view of the irrigation apparatus of the planter box of the present invention.

FIG. 5 is an assembled view of the planter box of the present invention with a cover member affixed.

FIG. 6 is an exploded view of yet another embodiment of the planter box of the present invention.

### DETAILED DESCRIPTION OF THE INVENTION

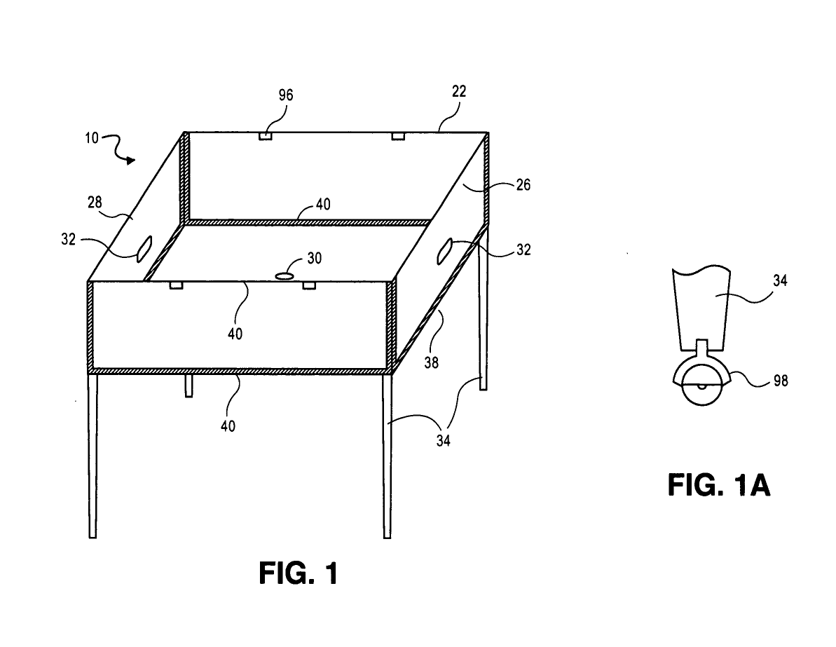

FIG. 1 illustrates, generally, an exemplary portable planter box 10 of the present invention. The Figures in toto represent a number of embodiments of the present invention, and should not be interpreted as illustrating every conceivable or possible embodiment of the invention. The scope of the invention should be limited solely by the scope of the Claims appended hereto. In this FIG. 1, there is illustrated a bottom panel 20 and four side panels 22, 24, 26 and 28. As illustrated in FIG. 1, the bottom panel 20 may be provided with one or more drain holes 30 to remove excess water. At least one of the side panels of the planter box 10 is provided with an orifice 32 within which is affixed a watering apparatus (described later). The planter box 10 may be provided with at least three legs 34, and preferably four, to elevate the planter box above the ground.

As illustrated in FIG. 1, the preferred embodiment of the planter box is a square or rectangular box with four side panels; however it is contemplated that the planter box would be just as effective if provided with three side panels, or five or more side panels. The planter box is preferably provided with a bottom panel 20 having dimensions typical of those utilized in commercial environments, such as 40″×48″. Such dimensions are typical of pallets utilized in the harvesting, transport, and storage of agricultural products.

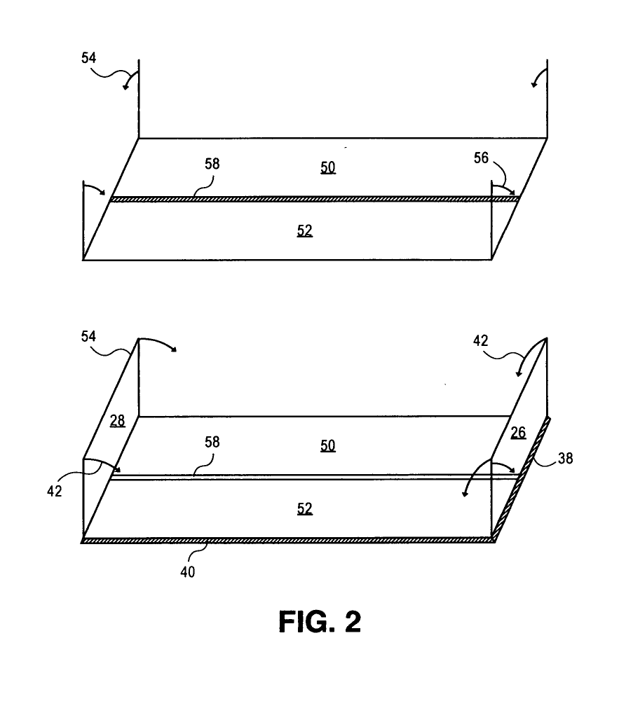

In order to more easily package, ship and store the planter box of the present invention, the box is preferably capable of being collapsed and/or disassembled. In one embodiment illustrated in FIG. 2, the end panels 26, 28 and side panels 22, 24 may be provided with means, such as hinge 38 to enable end panels to be hinged to the bottom and folded thereupon, as illustrated by arrow 42. The bottom panel may be provided in mated halves 50, 52, and likewise provided with a hinge 58 to enable the two halves to be folded one upon the other as illustrated at arrows 54, 56. Similarly, side panels may be hinged, as at 40, enabling the side panels to be hingably folded onto the bottom.

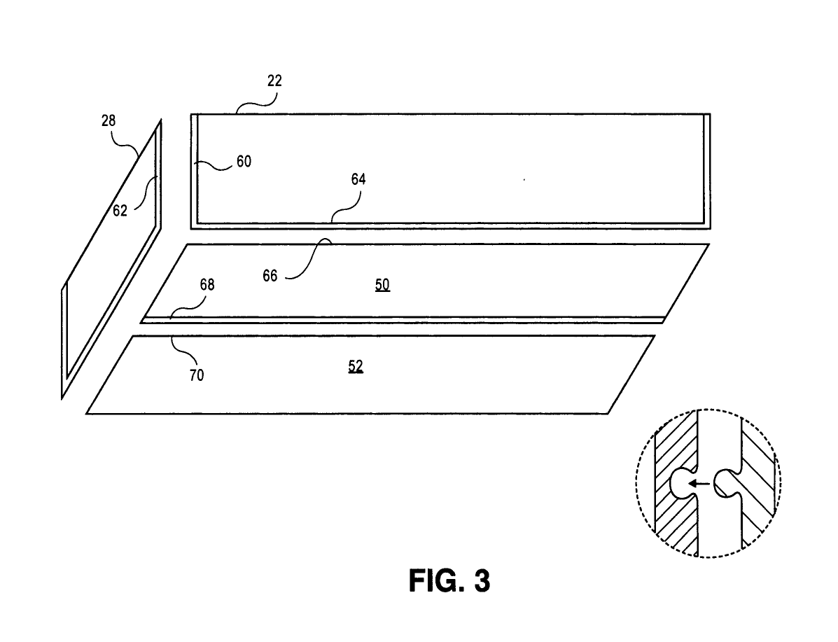

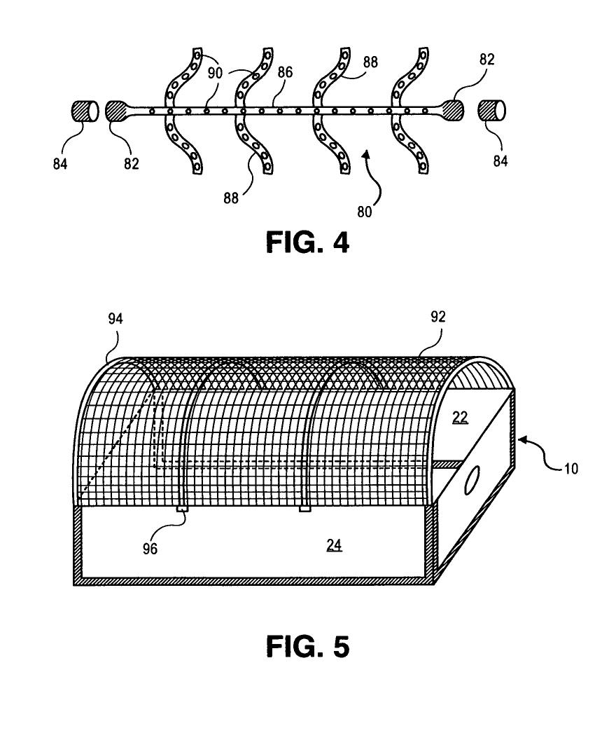

FIG. 3 illustrates an alternative embodiment to that illustrated in FIG. 2. Rather than hinge side panels 22, 28 to each other and to the bottom panel 50, the adjacent side and end panels may instead be provided with mating male/female members 60, 62 along their periphery that may slidably engage with one another, or which snap securely together. Likewise, the side panels may be provided with mating members 64, 66 which secure the side panels to the bottom panel. In yet another embodiment the two bottom panels 50, 52 may be hinged or slidably engaged 68, 70 to one another. Plants grown in the planter box of the present invention may be watered manually by the owner, or they can be watered by a watering system as exemplified at 80 in FIG. 4. An exemplary watering system will comprise at least one fitting 82 on the distal end of the watering system to interfit with an aperture 32 in a side wall 26, and is positioned within the box and either on top of or within the soil in the planter box. The fitting 82 may be constructed with, for example, a typical hose bib 84 to interfit with a conventional residential hose. The watering system may comprise an elongate member 86 with one or more lateral members 88, and may be provided with fittings 82, 84 at both ends of the elongate member 86. Any means of distributing water within the soil-filled box may be utilized and are well known, such as drip apertures 90.

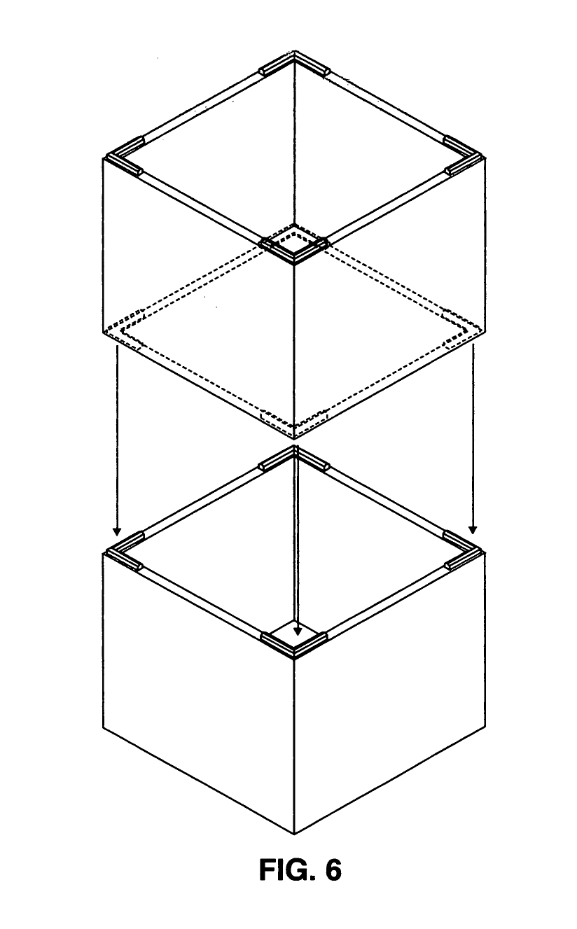

Growing seasons in most locales are restricted at the early and late portions of the growing season; this season can be extended if plants are provided shelter from ambient coot air. In FIG. 5, box 10 is provided with a cover member 92 having reduced or no air permeability. When exposed to direct or indirect sunlight the cover member 92 will act to retain heat within the soil and box and thereby extend the growing season for plants therein. The cover member 92 is preferably supported by support members 94, which may be comprised of metal, plastic or other deformable material. In a preferred embodiment, at least two of the opposing side walls 22, 24 are provided with receiving slots 96 to removably receive the ends of support members 94. The slots 96 may comprise voids in the rigid structure of the side walls or may be may be molded into or secured to the upper edge region of the side walls.

In order to make the planter box relatively portable, the legs 34 of the invention may be provided with casters 98 which may be removably affixed to the leg or permanently affixed to the legs.

Multiple planter boxes of the present invention may be adapted to be removably affixed adjacent to one another, either side-by-side or end-to-end. In this manner the planter boxes may be secured and made available for larger scale and more efficient production of foodstuffs.

The descriptions and drawings of the present invention are presented herein for purposes of illustration only. There are undoubtedly numerous minor modifications that could be made to the invention disclosed herein that will be within the scope of the invention. The specific metes and bounds of the invention should be deemed to be delineated solely by the scope of the Claims appended hereto.

I claim:

1. A portable planter box, comprising:
a. an open-top box portion having a bottom panel and at least three side panels;
b. at least three legs to elevate the box portion off the ground;
c. an internal watering line;
d. at least two of the side panels adapted to receive support members;
e. a flexible cover member adapted to interfit with the support members to cover and substantially enclose the box portion.

2. The portable planter box of claim 1, wherein adjacent edges of side panels and bottom panel are provided with means to permit the side panels to fold upon the bottom panel.

3. The portable planter box of claim 2 wherein the bottom panel is provided with means to permit the bottom panel to be folded in half.

4. The portable planter box of claim 1, wherein adjacent side panels are interconnected with one another and to a bottom panel with slidable male/female members to permit disassembly of the planter box.

5. The portable planter box of claim 1, wherein said legs are removable from the bottom panel.

6. The portable planter box of claim 1, wherein said legs are provided with casters to enable movement of the planter box.

7. The portable planter box of claim 1, wherein the corners of planter boxes are adapted to be removably intermitted with corners of planter boxes removably affixed above or below the planter box.

8. The portable planter box of claim 1, wherein the planter box is provided with an internal watering system comprising watering lines to distribute water throughout the planter box.

9. The portable planter box of claim 7, wherein fittings are provided on the distal ends of the watering lines such that watering systems of adjacent planter boxes may be [symbol] .

10. The portable planter box of claim 1, wherein multiple planter boxes are removably affixed to one another.
